(19) United States
(12) Patent Application Publication
(10) Pub. No.: US 2003/0070516 A1
(43) Pub. Date: Apr. 17, 2003

(54) Slug float detecting device and detection method thereof

(75) Inventor: Akira Harada, Kanazawa City (JP)

Correspondence Address: DARBY & DARBY P.C., P. O. BOX 5257, NEW YORK, NY, 10150-5257, US

(73) Assignee: AIDA ENGINEERING, LTD.

(21) Appl. No.: 10/210,302

(22) Filed: Aug. 1, 2002

(30) Foreign Application Priority Data
Oct. 16, 2001 (JP) 2001-317770

(51) Int. Cl. B26D 5/00; B23Q 15/00

(52) U.S. Cl. 83/13; 83/72

(57) ABSTRACT

A slug float detecting device comprising: a proximity member affixed on a stripper plate of press; an eddy-current sensor affixed on a lower die to measure clearance t for each increment of a crank angle; a memory device for storing a stripper motion that represents the relation between clearance t and the crank angle; and a calculating means for comparing the strip motion stored in the memory means with the stripper motion of the current stroke to detect a change, thus issuing abnormality warning signal to the press when said change is out of a specified range.

### TECHNICAL FIELD

The present invention relates to a slug float detecting device and its detecting method intended for detecting slugs that affect the results of press working, in particular, punching processes.

### BACKGROUND

It often happens in press working, in particular, in a punching process, that slugs generated in the process get stuck onto the punch and get deposited onto either the material that is being worked or the slugs get deposited on the lower die. This phenomenon is generally called “slug floating” and affects product accuracy if the process is continued without removing the slugs. It can damage the dies sometimes or even the machine due to overloading. Therefore, various devices for detecting slug floating have been proposed for detecting slug floating phenomena so that the machine can be stopped when slug floating is detected in order to prevent damages to the dies and the machine.

The Laid-Open Japanese Patent Application No. H2-9892 (title of the invention: “Automatic Control for Press”) discloses a slug float detection method consisting of detecting the bottom dead center of the stripper plate during the first stroke, recording it as a set point, comparing the bottom dead center during the next stroke with said set point, and stopping the machine if the two bottom dead centers differ assuming that slugs are deposited onto either the lower die or the material itself. In other words, a slug floating has occurred. The bottom dead center of the stripper plate refers to the bottom dead center of the first bounds when bounds occur as the stripper plate hits the lower die or the material being worked.

The problem here is that there can be a case where slug floating exists even though the bottom dead center coincides with the setup value (i.e., no abnormality is found in the bottom dead center). For example, a slug can be floating on the edge of the lower die. If a slug is on the top edge surface of the lower die, the stripper plate can tilt at the bottom dead center. This naturally causes one end of the stripper plate where the slug does not exist to be located lower than the other end where the slug exists. If the sensor for detecting the bottom dead center is provided on the side where the slug does not exist, the bottom dead center of the first stroke coincides with that of the second stroke so that the slug floating cannot be detected.

Even in such a case, the stripper plate maintains a horizontal attitude in the initial step of its contact with the material being worked despite the resistance of the slug. Therefore, the displacement of the stripper plate on the side where the slug does not exist (i.e., the side the sensor is located) is different from that of the previous stroke. However, the detection method disclosed by the Laid-Open Japanese Patent Application No. H2-9892 cannot detect any positions of the stripper plate other than the bottom dead center, so that it cannot detect the slug floating of such a case.

### SUMMARY

It is therefore an object to provide a new and improved slug floating detecting device and a method of use for detecting slug float detection, where the device is capable of detecting slug floating under any circumstances.

According to one exemplary embodiment, a device is provided for slug float detection and includes a detection means for detecting displacement of a stripper plate that is provided on a die in order to press down a material being worked. The displacement of the stripper plate is detected for each crank angle. The detection means also generates stripper motions that each represents a relation between the displacement of the stripper plate and the crank angle. For example, the detection means can generate a signal that is representative of a stripper motion for a particular stroke. The device also includes a memory means for storing the stripper motion generated by the detection means; a calculation means for detecting changes (variations) in the stripper motions by comparing the stripper motion generated by the current stroke and the stripper motion stored in the memory means; and an output means for outputting an abnormality warning signal to the press if the change amount detected by said calculation means is out of a specified range.

One exemplary detection means includes a sensor, such as an eddy-current sensor, or a linear scale and its measuring amplifier. The memory means, the calculation means, and the output means can be equipment such as a personal computer or a programmable controller (PLC), which contains all of these functions, and a software program.

The detection of the displacement of the stripper plate can be performed at an interval of any crank angle. For example, the detection can be done every 0.1 degree of the crank angle; however, this is merely illustrative and this value can be varied to another setting, such as 1.5 degrees or 0.5 degrees or another value corresponding to the link motion, etc. The range of crank angles for the detection does not have to be the entire range (entire 360 degrees of the crank angle) but rather can be only what is really needed for any particular application. More specifically, it can be the range from the time when the stripper plate contacts the material to the time when the stripper plate leaves the material after working the material. Moreover, the specified range used for comparing the stripper motion's changes can be arbitrarily defined as a range that is sufficient for detecting slug float in consideration of various press working conditions (the press speed, the thickness of the material to be worked, structure of dies, etc.).

Thus, the motions of the stripper plate are compared to detect the amount of change in the motion of the stripper plate. In other words, the present device and process are not limited to detecting the stripper plate displacement at a single point such as the bottom dead center, but rather the present device detects the displacement of the stripper plate (i.e., the amount of change) in order to be able to detect an abnormal displacement of the stripper plate (i.e., the amount of change of an abnormal or irregular displacement motion). Since the displacements of stripper plate can be detected in places other than the bottom dead center, the present device, as embodied by the various embodiments can detect slug float more securely in comparison with the detection devices or mechanism of the prior art.

According to a second embodiment, a device for slug float detection is provided and is similar to the device of the first embodiment; however, the stripper motion that is stored in the memory means is obtained by sampling.

In this second embodiment, the stripper motion is prepared and stored by test working (sampling) prior to the press operation. This causes the comparison conducted by the calculation means to be a comparison between the stripper motion on the current stroke and the stripper motion obtained in the sampling. According to this exemplary embodiment, it is possible to let an experienced worker do the sampling work, which is relatively more difficult, and let an ordinary worker do the subsequent actual production. Thus, a device according to a second embodiment provides a slug float detection device that is easier to use, in addition to having the features provided by the device of the first embodiment.

According to a third embodiment, a device for slug float detection is provided according to either the first or second embodiments; with the difference being that the detection means includes a proximity member affixed to the stripper plate, an eddy-current sensor affixed to the lower die facing said proximity member, and a measuring means of converting electrical signals from said eddy-current sensor into a clearance (i.e., a distance measurement) between the eddy-current sensor and the proximity member and outputting the relation between the clearance and the crank angle to the calculation means as the stripper motion (e.g., a signal representative of the stripper motion).

In the third embodiment, an eddy current sensor is used as the detection means. What is detected is the clearance (i.e., distance measurement) between the eddy current sensor and the proximity member affixed on the stripper plate. Since this clearance is related to the displacement of the stripper plate, it is conceptually the same as the displacement of the stripper plate. Therefore, if an appropriate process such as a calculation is applied to the relation between this clearance and the crank angle as a stripper motion, it is possible to achieve an effect similar to directly detecting the position of the stripper plate.

Furthermore, a more accurate detection can be expected from an eddy-current sensor, and the structure can be more simplified compared to the case of using other detectors (e.g., linear scale). Although the entire stroke (entire 360 degrees of the crank angle) cannot be detected using an eddy current sensor, a sufficient detection range can be secured. Therefore, according to the third embodiment, it is possible to reduce the manufacturing cost and provide a very accurate device for slug float detection.

According to a fourth embodiment, there is provided a device for slug float detection according to either one of the first through third embodiments, with the device further including a display means constituted to be able to display the stripper motion.

In the fourth embodiment, it is possible to display the stripper motion of the current stroke in real time and also in comparison with the stored stripper motion by having the display capable of displaying the stripper motion. Thus, the fourth embodiment provides a device for slug float detection that makes the operator easier to understand press working in addition to the effects provided by either one of the first through third embodiments.

According to a fifth embodiment of the invention, there is provided a method for slug floating detection that controls a press characterized in preparing and storing stripper motion that represents displacement of the stripper plate for each crank angle, calculating stripper motion's change by comparing the stripper motion of the current stroke and the stored stripper motion, and outputting an abnormality warning signal if the calculated change exceeds a specified range.

By implementing the device according to the fifth embodiment in the slug float detection, an effect similar to that obtainable in the first embodiment can be obtained.

According to a sixth embodiment, there is provided a method for slug floating detection that controls a press characterized in storing stripper motion that represents displacement of the stripper plate for each crank angle by means of sampling, detecting the change of the stripper motion by comparing the stripper motion of the current stroke with the stored stripper motion during the sampling, and outputting an abnormality warning signal if the calculated change exceeds a specified range.

By implement the invention according to the sixth embodiment in the slug float detection, an effect similar to that obtainable in the second embodiment can be obtained.

The above, and other objects, features and advantages of the present device will become apparent from the following description read in conjunction with the accompanying drawings, in which like reference numerals designate the same elements.

### BRIEF DESCRIPTION OF THE DRAWING FIGURES

FIG. 1 is a block diagram showing an embodiment of the invention including a schematic diagram of dies;

FIG. 2A is a stripper motion diagram under normal conditions;

FIG. 2B is a stripper motion diagram, wherein a change amount is detected; and

FIG. 2C is a stripper motion diagram showing a specified range.

### DETAILED DESCRIPTION OF PREFERRED EMBODIMENTS

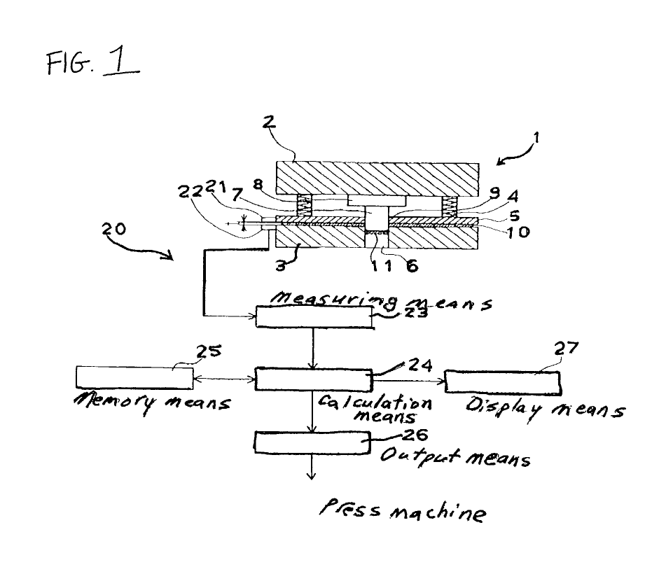

FIG. 1 shows an exemplary embodiment of the present invention. In FIG. 1, a die assembly is generally indicated at 1 and includes a plurality of dies. Die assembly I includes an upper die 2 and a lower die 3. Upper die 2 is provided with a stripper plate 5 which is coupled thereto with a spring 4 which is disposed therebetween. Lower die 3 is equipped with a die 6, while upper die 2 is equipped with a punch 7 in correspondence with die 6 such that the two axially align with one another. Upper die 2 also has a punch holder 8 for affixing punch 7 to upper die 2. A hole 9 is provided on stripper plate 5 in correspondence with punch 7. Upper die 2 is normally affixed to the slide of the machine (not shown), and lower die 3 is affixed to the bolster (not shown).

In a normal press working, a sheet material 10 is supplied between stripper plate 5 and lower die 3, while upper die 2 (together with the slide of the machine, which is not shown) goes up and comes down from the top dead center. As upper die 2 comes down, stripper plate 5 contacts and applies a force on the sheet material 10 (i.e., the stripper plate 5 presses down on the sheet material 10). When upper die 2 further comes down against a damping action of spring 4, sheet material 10 is punched out by coordination of punch 7 and die 6.

When dies 1 perform a punching process such as the above described one, a slug 11 is generated. Slug 11 often goes up as it is attached to punch 7 (upper die 2). As a consequence, it often gets deposited between the upper face of lower die 3 and the lower face of sheet material 10 or between the upper face of sheet material 10 and the lower face of stripper plate 5. If the press working is continued in the next stroke and thereafter while slug 11 is deposited on the upper face of lower die 3 or the upper face of sheet material 10, it can affect the product accuracy and may cause overload, which may lead to damages of dies 1 and the machine (not shown).

Therefore, a slug float detecting device 20 is provided to detect slugs and to stop the machine immediately when slugs are detected. Slug float detecting device 20 comprises a proximity member 21 affixed to the edge of stripper plate 5, an eddy-current sensor 22 affixed on the edge of lower die 3 facing against proximity member 21, and a measuring means 23, which is connected electrically to eddy-current sensor 22. The measuring means 23 converts the electrical signals from eddy-current sensor 22 to the stripper motion that represents the relation between the displacement of the stripper plate 5 and the crank angle. In other words, the measuring means 23 generates a signal that represents the stripper motion (i.e., defined by the aforementioned relation).

Measuring means 23 is connected electrically to a calculation means 24 that conducts various calculations. In the meanwhile, a memory means 25 that stores the detected stripper motion is connected electrically to calculation means 24 and exchanges memory data in coordination with calculations of calculation means 24. The calculation results of calculating means 24 are outputted to the press via output means 26. Display means 27 is constituted to be able display the stripper motion based on the instructions of calculation means 24.

More specifically, measuring means 23 comprises an amplifier for the eddy-current sensor 22 and a software program, calculating means 24 comprises a CPU and its software program of a personal computer, a programmable logic circuit (PLC), etc., the memory means consists of RAM, etc., the output means consists of an I/O device, etc., and the display means consists of a display, etc.

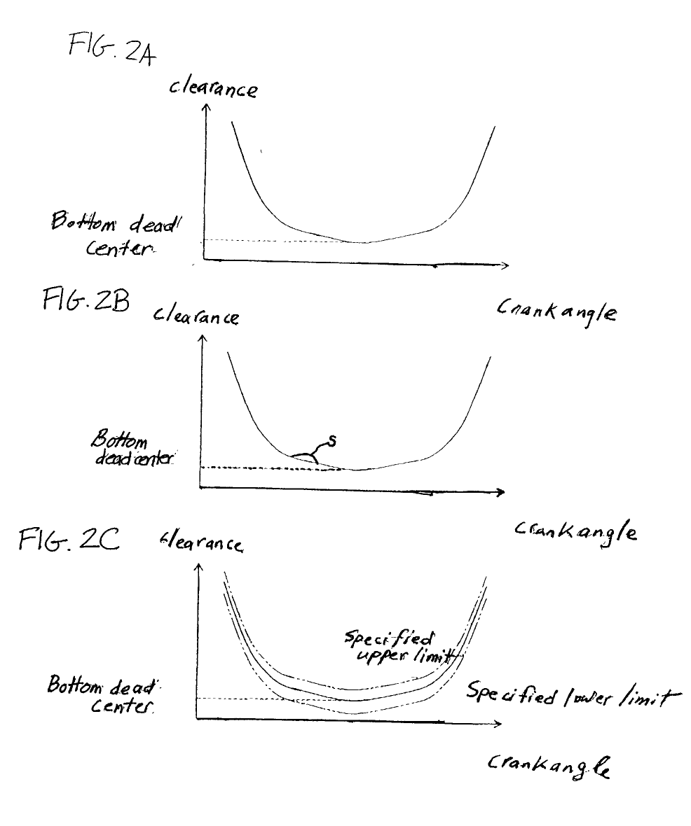

The following is a description of the stripper motion outputted by measuring means 23. Eddy-current sensor 22 detects its distance from proximity member 21, i.e., clearance t shown in FIG. 1, for each increment of crank angle of the press (not shown). For example, clearance t is measured each 0.1-degree advancement of the crank angle. The relation between clearance t measured each crank angle increment and the crank angle is called stripper motion. FIGS. 2 (A), (B) and (C) shows the graphs of various exemplary stripper motions.

Clearance t does not have to be detected for a fixed interval of the crank angle but rather can be detected for an irregular interval of the crank angle (e.g., for an interval that progressively changes). Moreover, eddy-current sensor 22 and proximity member 21 can be replaced with a linear scale or something similar to it to measure the absolute position of the stripper plate 5 against a certain increment of the crank angle to produce a similar stripper motion.

The detecting device 20 works as follows. As upper die 2 strokes up and down, so does stripper plate 5. The eddy-current sensor 22 measures clearance t, and a stripper motion is generated by means of measuring means 23 (FIG. 2 (a)). This stripper motion is then stored in memory means 25 via calculation means 24. Another stripper motion is generated in the next stroke (FIG. 2 (B)).

The stripper motion stored in storage means 25 is then called out by calculation means 24. For example, the signal representative of the stripper motion is transmitted/delivered to the calculation means 24. Calculation means 24 compares the stripper motion with the stored stripper motion (FIG. 2 (B)). If the area that differs from the stored stripper motion, i.e., change S, is out of the predetermined specified range that can be inputted by the operator or the like or can be determined as described below, it is judged that an abnormality (i.e., a slug floating) exists and an abnormality signal is transmitted from output means 26. Upon generation and transmission of the abnormality signal, the machine stops and it is then possible to take actions such as removal of slugs.

This specified range can be defined arbitrarily as a range (upper limit and lower limit) that is sufficient for detecting slug float in consideration of various press working conditions (the press speed, the thickness of the material to be worked, structure of dies, etc.). (FIG. 2 (B)) Since stripper plate 5 is located higher than normal when slug floating occurs, the upper limit is the key element of the specified range.

Thus, it is possible to conduct press works within a certain tolerable range, if the machine (not shown) and dies 1 have some ranges of tolerance, by specifying a certain tolerance range and monitoring change S, which is detected by comparing the stored stripper motion with the stripper motion of the current stroke, with reference to the specified range.

The stripper motion to be stored in memory means 25 can be the stripper motion of the first stroke (of the process), and the stripper motions of all the subsequent strokes can be compared to said stripper motion of the first stroke. On the contrary, it is also possible to update the stripper motion to be stored each time a stroke is made, and to compare the stripper motion of the current stroke with that of the stroke immediately ahead of it (i.e., the immediately preceding stroke).

It is also possible to store a stripper motion sampled when the press (not shown) and dies 1 are in good conditions (e.g., in terms of temperature) in memory means 26. In this case, change amount S is detected by calculation means 24 by comparing the stripper motion based on the sampling and the stripper motion of the current stroke. According to this scheme, it is possible to let an experienced worker do the sampling work, which is relatively more difficult, and let an ordinary worker do the subsequent actual production.

Display device 27 can display various kinds of stripper motions. It is constituted in such a way to be able to display the stripper motion stored in memory means 25 and the stripper motion of the current stroke simultaneously (side by side or overlapping).

According to the invention of the first embodiment, the position of stripper plate 5 is detected within a certain width of crank angle (within a range of stroke) and a stripper motion that represents the relation between the stripper plate's displacement and the crank angle is determined. This stored (normal) stripper motion and the stripper motion of the current stroke are compared to detect the change to be used for judging whether a slug float condition or the like has occurred. Therefore, slug float detection can be made at the bottom dead center as well as other points, so that the slug float detection can be done more securely than previously possible. A similar effect can be obtained by applying the device according to the previously-described fifth embodiment to the slug float detection.

According to the second embodiment, the change can be detected by a comparison between the stripper motion of the current stroke and the stripper motion obtained in the sampling. Therefore, it is possible to let an experienced worker do the sampling work, which is relatively more difficult, and let an ordinary worker do the subsequent actual production. Thus, the second embodiment of the invention provides a slug float detection device that is easier to use, in addition to the features provided by the first embodiment of the invention. A similar effect can be obtained by applying the invention of the sixth embodiment to the slug float detection.

According to the invention of the third embodiment, it is possible to provide a slug float detecting device of a simple construction, thus reducing manufacturing cost despite its high accuracy. Further, in the fourth embodiment of the invention, it is possible to display the stripper motion on the display, so that it provides a device for slug float detection that makes the operator easier to understand press working in addition to the effects provided by either one of the first through third embodiments.

While the invention has been particularly shown and described with reference to preferred embodiments thereof, it will be understood by those skilled in the art that various changes in form and details can be made without departing from the spirit and scope of the invention.

What is claimed is:

1. A device for slug float detection comprising:
a detection means for detecting displacement of a stripper plate provided on a die of a press in order to press down a material being worked, the displacement being detected for each crank angle, wherein the detection means generates stripper motions that each represents the relation between the displacement of the stripper plate and the crank angle;
a memory means for storing said stripper motion generated by said detection means;
a calculation means for detecting changes in the stripper motions by comparing the stripper motion representative of a current stroke with the stripper motion stored in the memory means; and
an output means for outputting an abnormality warning signal to the press if the change amount detected by said calculation means is outside of a specified range.

2. A device for slug float detection according to claim 1, wherein said stripper motion that is stored in said memory means is obtained by sampling.

3. A device for slug float detection according to claim 1, wherein said detection means comprises:
a proximity member affixed to the stripper plate;
an eddy-current sensor affixed to the lower die facing said proximity member; and
a measuring means for converting electrical signals generated by said eddy-current sensor into a clearance value representing a distance between said eddy-current sensor and said proximity member and outputting a signal that represents a relation between said clearance value and the crank angle to said calculation means, said output signal defining said stripper motion.

4. A device for slug float detection according to claim 1, further comprising:
a display means configured to display said stripper motion.

5. A device for slug float detection according to claim 3, wherein the clearance value is detected each 0.1 degree advancement of the crank angle.

6. A device for slug float detection according to claim 1, wherein said stripper motion that is stored in said memory means comprises the stripper motion of a first stroke.

7. A device for slug float detection according to claim 1, wherein said calculating means compares the stripper motion of a current stroke with the stripper motion of an immediately preceding stroke.

8. A device for slug float detection according to claim 4, wherein the display means displays said stripper motion stored in memory means with said stripper motion of a current stroke in a side by side manner.

9. A device for slug float detection according to claim 4, wherein the display means displays said stripper motion stored in memory means with said stripper motion of a current stroke in an overlapping manner.

10. A device for slug float detection comprising:
a detection means for detecting displacement of a stripper plate disposed on a die of a press in order to press down a material, the detection means detecting the displacement for each crank angle, wherein the detection means generates a stripper motion profile that represents the relation between the displacement of the stripper plate and the crank angle for each stroke;
a memory means for storing said stripper motion profile generated by said detection means;
a calculation means for comparing the stripper motion profile of a current stroke with the stripper motion profile stored in the memory means and detecting any difference between the current stripper motion profile and the stripper motion profile stored in memory; and
an output means for outputting an abnormality warning signal if the difference detected by said calculation means exceeds a threshold value.

11. A device for slug float detection according to claim 10, wherein the detection means comprises:
a proximity member affixed to the stripper plate;
an eddy-current sensor affixed to the lower die facing said proximity member; and
a measuring means for converting electrical signals generated by the eddy-current sensor into a clearance measurement that represents a distance between the eddy-current sensor and the proximity member and outputting the stripper motion signal to the calculation means, where the stripper motion signal represents a relation between the clearance measurement and the crank angle.

12. A method for slug floating detection that controls a press, the method comprising the steps of:
generating and storing a stripper motion that represents a displacement of a stripper plate for each crank angle;
calculating a change in the stripper motion by comparing the stripper motion of a current stroke and the stored stripper motion; and
outputting an abnormality warning signal if the calculated change exceeds a specified range.

13. A method according to claim 12, wherein the step of generating a stripper motion comprises the steps of:
detecting displacement of the stripper plate for each crank angle; and
generating a signal that represents a relation between the displacement of the stripper plate and the crank angle for each stroke.

14. A method according to claim 13, wherein the step of detecting displacement of the stripper plate comprises the steps of:
affixing a proximity member to the stripper plate;
affixing an eddy-current sensor to a lower die, the eddy-current sensor facing the proximity member;
converting electrical signals generated by the eddy-current sensor with a measuring means into a clearance measurement representing a distance between the eddy-current sensor and the proximity member; and
outputting a signal from the measurement means to calculation means, wherein the output signal represents a relation between the clearance measurement and the crank angle, the output signal representing the stripper motion for a stroke.

15. A method for slug floating detection that controls a press characterized in:
storing a stripper motion that represents a displacement of a stripper plate for each crank angle by means of sampling;
detecting a change in the stripper motion by comparing the stripper motion of a current stroke with the stored stripper motion during the sampling; and
outputting an abnormality warning signal if the calculated change exceeds a specified range.
